(19) United States
(12) Patent Application Publication
(10) Pub. No.: US 2012/0032851 A1
(43) Pub. Date: Feb. 9, 2012

(54) EMITTER LOCATION

(75) Inventor: Keith Horsey, Essex (GB)

(73) Assignee: Selex Sensors & Airborne Systeme Limited, Basildon (GB)

(21) Appl. No.: 12/521,521

(22) PCT Filed: Jan. 8, 2008
(86) PCT No.: PCT/EP08/50127

§ 371 Date: Feb. 19, 2010

(30) Foreign Application Priority Data
Jan. 9, 2007 (GB) 0700299.1
Jan. 9, 2007 (GB) 07270002.4

(51) Int. Cl. G01S 5/04

(52) U.S. Cl. 342/442

(57) ABSTRACT

The present invention relates to emitter location. More specifically, it relates to locating emitters using only their fundamental frequency information.

The present invention recites a method of determining the location of an emitter source comprising the steps of receiving signal information from the source at a plurality of sensors; and simultaneously processing a large bandwidth, and all received signal information using the fundamental RF frequency that lay within the detection bandwidth, and simultaneously determining the relative time of arrival, of all detected signals, using their relative post FFT fundamental detected phases, and using analysis of these relative instantaneous phases to determine all signal source directions within the detected bandwidth. The present invention also recites an apparatus comprising: a first sensor; at least one other sensor located remotely from the first sensor; a central processor connected to the first sensor and each of said other sensors for receiving signal information from each sensor relating to an emitter source and for determining location of emitter sources using their fundamental RF frequency and the technique above.

The present invention relates to emitter location, using only frequency information.

Traditionally, emitter location has relied on first establishing the target frequency, calibrating equipment, then direction finding and triangulation. Antenna systems are often very large in order to achieve acceptable pointing accuracies, especially at low frequencies. Extensive signal processing of target signal waveforms and characteristics is often necessary to average out pointing errors on particular signals and separate one signal from another in multi-target transmission scenarios.

It is therefore an object of the present invention to provide a method and apparatus for simultaneously finding the position of a number of emitter sources using only RF frequency without first having to establish their target frequencies.

According to one aspect of the invention, there is provided a method of determining the location of an emitter source comprising the steps of receiving signal information from the source at a plurality of sensors; and processing the received signal information using the fundamental RF frequency to direction find and ultimately determine the location of all emitter sources within the area of interest, and within an expected capture bandwidth.

According to another aspect of the invention, there is provided an apparatus comprising: a first sensor; at least one other sensor located remotely from the first sensor; a central processor connected to the first sensor and each of said other sensors for receiving signal information from each sensor relating to emitting sources and for determining location of emitting sources using their fundamental RF frequency.

An advantage of the present invention is that the system functional topology acquires large signal bandwidth simultaneously. This leads to it being possible to process all signal and target data rapidly and minimise the time required to make location data available to a user of a system according to the present invention.

Another advantage of the present invention is that only small volumes of data are received from each system sensor and that command and/or observation source data relaying, to another location, is possible using low bandwidth methods.

A further advantage of the present invention is that location, positioning and tracking of both fixed frequency and agile emitters is possible and that numerous map, terrain image and aerial photographic formats can be accommodated and geo-referenced into such a system.

Preferably the system will use small, unmanned, battery powered location system sensors. These can be easily deployed. A post deployment calibration process can be used, against known geolocated sources, to fine tune sensor and system variables, improving system accuracy.

Also preferably, the system would be able to operate with only two location sensors, but can operate with more. Additional sensors can enhance system accuracy and sensor redundancy.

Preferably the command and/or observation location may be remote from the system sensors and area of interest.

It is also preferable that the position of all observed target transmissions can be identified, with geo-referencing of all data available to enable users of the system to more easily locate emitters. It is further preferable to incorporate onboard sensor calibration to minimise geo-referencing errors, positional errors and sensor pointing errors. This level of sensor calibration is enhanced further by a post deployment system calibration process.

Specific embodiments of the invention will now be described, by way of example only and with reference to the accompanying drawings that have like reference numerals, wherein:—

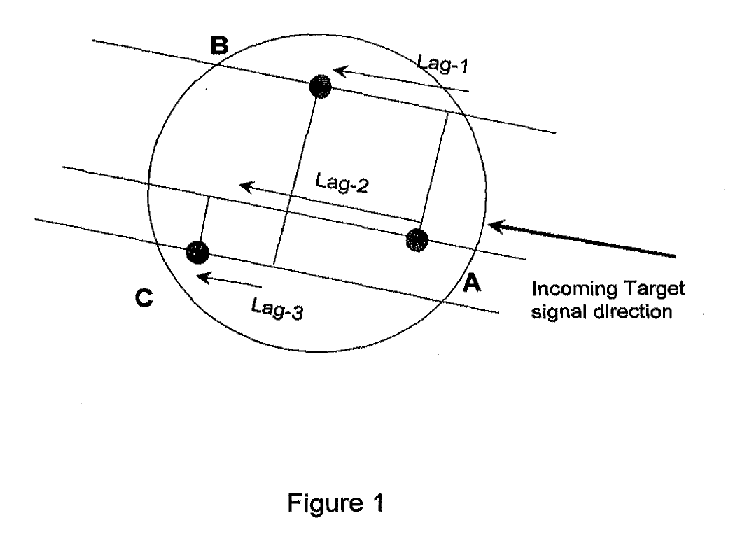

FIG. 1 illustrates a system sensor antenna array concept showing the related fundamental signal phase lag relationship to incoming target signal direction;

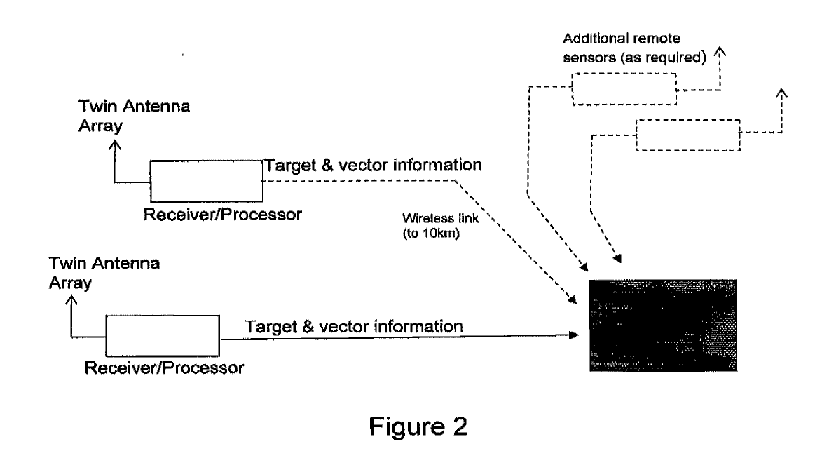

FIG. 2 illustrates the system locating and tracking process; whereby information is gathered from each system sensor, using a low bandwidth, non-time critical communications path; and

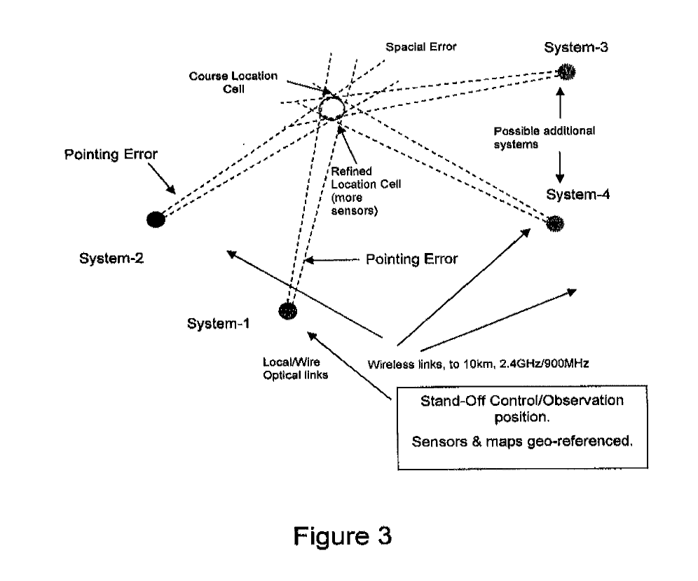

FIG. 3 illustrates the target location for the process used in FIG. 1 and FIG. 2.

Specific embodiments of the present invention shown in FIGS. 1 to 3 will now be described in more detail:

In a first embodiment of the present invention, there is provided a two or three element/sub-system sensor as depicted in FIG. 1, which is described below.

In FIG. 1, each of the sensors nodes A, B and C, represents a partially independent receiving and signal processing path.

Using a broadband scan sufficient signal spectrum samples are gathered to enable the simultaneous processing of a whole block of fundamental potential target signals in the spectrum of interest. A long Fast Fourier Transform (FFT) is used to transform sensors samples, observed in the time domain, into the frequency domain. The FFT is sufficiently long to enable sufficient frequency resolution to be extracted for the area and spectrum of interest. All potential emission frequencies are acquired simultaneously. For each post FFT frequency in the scan, its observed amplitude and frequency acquired.

In a complex transform, the phase information pertaining to the random signal arrival at a processing sensor node, which can be determined using analysis of the real and imaginary components in the transform output, and which are available for every frequency captured is usually irrelevant since characteristics of the target signal(s) are completely asynchronous to the location system, its FFTs and processing. However, if more than one receiving node (antenna element in FIG. 1) is used and more than one channel of data is sampled simultaneously, at each sensor, then the phase information from each fundamental frequency in the area of interest and the captured bandwidth can be compared at each sensor, thus making direction possible to determine. Each sub-system sensor can then be related to its partner to determine location as illustrated in FIG. 3.

At each emitter location node, every frequency observed by the antenna sensor array will have phase references depending on the orientation of the sensor to each fundamental signal source in the area of interest. At each specific frequency the relative phase information between one sensor antenna and another, can be related to a time lag allowing direction to be deduced. See FIG. 1.

Since the duration of the capturing scan in the proposed system is very very short, signal characteristics and modulation waveforms will be irrelevant, leaving only the target signal fundamental to be processed. This negates the need for extensive and expensive post reception signal processing techniques. In addition, frequency agile AJ (anti-jam) targets are treated in much the same way as fixed frequency target transmissions, potentially enabling location of AJ emitting sources or fast moving sources.

The skilled person should also understand that a system according to the present invention would involve a minimum of two nodal antenna sensors and so, in a second embodiment of the invention, a simpler two element approach is envisaged. In this second embodiment, such a system would rely on other sensors in the overall system to resolve direction unambiguously, as will be described more fully below. Though this second two node sensor is potentially not as accurate, the supporting sub-system receiving and processing hardware is also simplified as less data needs to be processed.

Referring now to FIG. 2, the envisaged overall system would employ two or more of these co-operating antenna sensors, of either the first or second embodiments described above, as well as other systems sited a few hundred meters or a kilometre or so remotely. Having the ability to compute two vectors for each target signal at each antenna sensor, the overall system would be able to point to the precise location of all and every emitter captured during the scan time, within the scan bandwidth.

Referring now to FIG. 3, it can be seen that each of the sub-system sensors provides a vector to each emitter captured, enabling the target location to be determined.

A mathematical model has been developed to explore issues of accuracy, detection and pointing algorithms, and the potential effects of errors and mismatches on such a system. In this, a simulated signal, with separate phase offsets (representing the observable phase at separate antenna) is processed in parallel, simulating a duplex antenna array and receiver/processor chain. The model involves digitising and mixing in separate paths to produce separate I/Q channels. Each is decimated and undergoes a complex Fast Fourier Transform to provide separate (but identical) Fast Fourier Transform magnitude/frequency arrays and separate (but different) phase arrays. For a 1024 point transform, the result contains a 1024 amplitude/frequency variable and two 1024 phase angles pertaining to the phase of the incoming target signal at each sensor node. This is realised within the demonstrator hardware.

Using the mathematical model, it has been possible to show that the relationship between the separate phase results for each frequency is dependant on the phase of arrival of the original input target signal. Comparing the phases of arrival at one node thus enables a direction vector to be determined for a given frequency.

Simple rules and algorithms using basic trigonometry and rectangular techniques have been used to simplify this, interpreting the model results and recovering a direction under all conditions.

Two existing PCBs have been adapted to enable the sampling hardware on one to be driven and processed by the firmware on the other, thus enabling simultaneous sampling to be archived in two channels. The host firmware was modified to enable the two simultaneously gathered data sets to be transformed, retaining the real and imaginary parts of the transform in which the phase information could be extracted. This modified hardware/firmware arrangements was thus able to function demonstrating a single emitter location (EL) node or sub-system.

In order to demonstrate this a PC based interface was provided for a user to interrogate the EL sensors and read back target vectors. It is envisaged that by using proprietary mapping, various map formats and geo-referenced photographic terrain data, emitter positions could be overlaid in the form of icons. An example could involve overlaying a local ordinance map, and placing coloured icons to show the locations of target emitters. More complex map formats, using several layers, would allow levels of user de-clutter to be applied to simplify the map if needed.

A single computer will be able to act as a command and control position, communicating with several EL nodes—some local using serial/optical links and some remote using wireless links.

In an alternative embodiment, it may also be possible to re-use existing field assets (antenna systems currently in use) and also may be possible to integrate other sensor sources into this common and control position, such as acoustic, seismic and optical sensors.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of determining the location of one or more emitter sources comprising the steps of:
receiving signal information from the one or more sources at a plurality of sensors;
processing the received signal information using the fundamental RF frequency to determine the location of the one or more emitter sources;
simultaneously gathering emitter frequency data for a large instantaneous bandwidth,
determining the relative direction data of the one or more emitter sources; and
cross-referencing locations of the one or more emitter sources using these direction data by use of simple triangulation, trigonometry and rectangular techniques.

2. A method according to claim 1 wherein the step of determining the relative direction data of the one or more emitter sources uses simultaneous post FFT phasal comparison of the fundamental emitter frequencies and two or more antenna nodes.

3. A method according to claim 1 identifying
the location of the one or more emitter sources on a display of geo-referenced data.

4. A method according to claim 1 wherein each said sensor has onboard sensor calibration for reducing errors in geo-referencing, position and sensor pointing.

5. A method according to claim 1 wherein the said plurality of sensors are small battery powered location system sensors.

6. An apparatus comprising:
a first sensor;
at least one other sensor located remotely from the first sensor;
a central processor connected to the first sensor and each of said other sensors for receiving signal information from each sensor relating to an emitter sources and for determining location of emitter sources by
receiving signal information from the one or more sources at a plurality of sensors;
processing the received signal information using the fundamental RF frequency to determine the location of the one or more emitter sources;
simultaneously gathering emitter frequency data for a large instantaneous bandwidth,
determining the relative direction data of the one or more emitter sources; and
cross-referencing locations of the one or more emitter sources using these direction data by use of simple triangulation, trigonometry and rectangular techniques.

7. An apparatus according to claim 6, wherein the determining of the relative direction data of the one or more emitter sources uses simultaneous post FFT phasal comparison of the fundamental emitter frequencies and two or more antenna nodes.

8. An apparatus according to claim 6, wherein the central processor identifies the location of the one or more emitter sources on a display of geo-referenced data.

9. An apparatus according to claim 6, wherein the said plurality of sensors are small battery powered location system sensors.

10. An apparatus according to claim 6, wherein the said plurality of sensors are small battery powered location system sensors.
